(19) United States
(12) Patent Application Publication
(10) Pub. No.: US 2009/0169975 A1
(43) Pub. Date: Jul. 2, 2009

(54) Electrode, Fuel Cell Electrode, Fuel Cell, and Production Method of Electrode

(75) Inventors: Toru Shiraishi, Yokohama-shi (JP); Akihiro Katsuya, Yokohama-shi (JP); Osamu Yamashita, Tokyo (JP); Hidekazu Kimura, Tokyo (JP); Hiroshi Kajitani, Tokyo (JP)

Correspondence Address: OLIFF & BERRIDGE, PLC, P.O. BOX 320850, ALEXANDRIA, VA, 22320-4850, US

(73) Assignees: NHK SPRING CO., LTD, YOKOHAMA-SHI (JP); NEC CORPORATION, TOKYO (JP)

(21) Appl. No.: 12/226,057

(22) PCT Filed: Apr. 6, 2007
(86) PCT No.: PCT/JP2007/057750

§ 371 Date: Oct. 7, 2008

(30) Foreign Application Priority Data
Apr. 11, 2006 (JP) 2006-108409

(51) Int. Cl. H01M 4/02; B32B 38/04

(52) U.S. Cl. 429/44; 156/256

(57) ABSTRACT

An electrode has a metal fiber sheet and a thin sheet metal pattern connected to the surface of the metal fiber sheet and has a line pattern that runs on the metal fiber sheet. The line pattern includes an annular pattern that is provided on the peripheral edge of the metal fiber sheet and has an inside area, and the line pattern includes a bridge portion dividing the inside area of the annular pattern.

### TECHNICAL FIELD

The present invention relates to a structure of an electrode that may be suitably used for a fuel cell. Specifically, the present invention relates to a structure formed by connecting a thin sheet metal to a metal fiber sheet, and relates to a production method thereof. Moreover, the present invention relates to a fuel cell using a fuel cell electrode having the above structure.

### BACKGROUND ART

As a fuel cell electrode, an electrode using a mesh or a porous conductive member that allows passage of air is known. In this case, the electrode is formed so as to allow air to pass, so that fuel and an oxidant are efficiently fed to catalysts. As the conductive member that allows air to pass, a metal fiber sheet made of metal fibers that are formed into a sheet shape is known. A fuel cell electrode using metal fibers is disclosed in Japanese Unexamined Patent Application Publication (Translation of PCT Application) No. 2005-515604 and WO2004-075321, for example.

The metal fiber sheet is made of a fibriform porous material, and the metal fibers are entangled with each other and form point contacts. At the microscopic level, an electric current is conducted by the point contacts. In general, when the thickness of a conductor is decreased, electrical resistance (sheet resistance) in a direction parallel to the primary surface is increased, and electrical resistance in a direction perpendicular to the primary surface is decreased. In the metal fiber sheet, the effect of this phenomenon is large.

This phenomenon may cause a problem in a flat stacked-type fuel cell in which plural single electric power generating units are arranged so as to have a flat shape and are connected in series. That is, in the flat stacked-type fuel cell, an electric current flows in a direction parallel to electrode planes during generation of electric power. Therefore, if electrical resistance in a direction parallel to the electrode plane is large, power generating efficiency is decreased. This problem becomes apparent when the thickness of the metal fiber sheet is decreased so as to thin the flat stacked-type fuel cell. On the other hand, in a case of a vertically stacked structure in which single electric power generating units are stacked in a direction perpendicular to the primary surfaces thereof, an electric current flows in a direction perpendicular to electrode planes. Therefore, even when the electrical resistance of the metal fiber sheet in a direction parallel to the surface thereof is large, the above problem does not occur.

### DISCLOSURE OF THE INVENTION

The present invention relates to an electrode using a metal fiber sheet, which can be used for a flat stacked-type fuel cell, and an object of the present invention is to provide a technique for achieving a high power generating efficiency.

The present invention provides an electrode comprising a metal fiber sheet and a thin sheet metal pattern that is connected to the surface of the metal fiber sheet and has a line pattern running on the metal fiber sheet. The line pattern includes an annular pattern that is provided on the peripheral edge of the metal fiber sheet and an inside area, and the line pattern also includes a bridge portion dividing the inside area of the annular pattern. According to the present invention, the thin sheet metal functions as a collecting electrode and collects an electric current so that the electric current may not flow in the metal fiber sheet in a direction parallel to the surface thereof. Therefore, even when the electrical resistance of the metal fiber sheet in a direction parallel to the surface thereof is large, the electrode has a small electrical resistance in a direction parallel to the surface of the electrode. Specifically, as the line pattern of the thin sheet metal, an annular pattern and a bridge portion dividing the inside area of the annular pattern are provided to the electrode. Therefore, for example, when the electrode is used as a fuel cell electrode, fuel and an oxidant can be smoothly provided, and an electric current path in a direction parallel to the surface of the metal fiber sheet can be efficiently secured.

In the present invention, the metal fiber sheet is preferably made of an alloy of Fe and Cr, and Cr is desirably included at 10 to 30% by weight. In this condition, the metal fiber sheet and the thin sheet metal can be diffusion bonded by sintering with good bonding condition. The thin sheet metal pattern is desirably made of the same material as that of the metal fiber sheet. In this case, the metal fiber sheet and the thin sheet metal pattern can be bonded securely.

In the present invention, the difference in thermal expansion coefficient between the metal fiber sheet and the thin sheet metal pattern is desirably not more than 3×10⁻⁶/K. In this case, when the metal fiber sheet and the thin sheet metal pattern are bonded, bending occurring thereat can be reduced to a degree to which problems may not occur in practical use. The difference in the thermal expansion coefficient between the metal fiber sheet and the thin sheet metal pattern is more desirably not more than 1×10⁻⁶/K. In this condition, when the metal fiber sheet and the thin sheet metal pattern are bonded, bending thereof can be almost completely reduced.

In the present invention, the thin sheet metal pattern desirably has a thickness of not more than 0.2 mm. In this condition, even when there is a difference in the thermal expansion coefficient between the metal fiber sheet and the thin sheet metal pattern, bending thereof can be reduced to a degree to which problems may not occur in practical use. In this case, the lower limit of the thickness of the thin sheet metal pattern is approximately 0.05 mm in order to secure a low electrical resistance.

In the present invention, the metal fiber sheet and the thin sheet metal pattern are desirably connected by diffusion bonding performed by sintering. In this case, the metal fiber sheet and the thin sheet metal pattern are connected so as to be unitary, whereby a contact resistance therebetween can be sufficiently reduced. Moreover, the metal fiber sheet and the thin sheet metal pattern are stably bonded, whereby the contact resistance is not easily increased by corrosion, and a fuel cell having a stable performance can be obtained, for example. Alternatively, the metal fiber sheet and the thin sheet metal pattern may be bonded by soldering, although the soldering has less reliability than that of the diffusion bonding performed by sintering.

The electrode of the present invention is suitably used as a fuel cell electrode. In this case, the line pattern of the thin sheet metal desirably covers the surface of the metal fiber sheet at 20 to 80% of the surface area. As a result, feeding paths of fuel and an oxidant necessary for operating a fuel cell can be secured, and an extracting path of an electric current generated, which is necessary for a fuel cell electrode, can be secured. When the area of the line pattern of the thin sheet metal on the surface of the metal fiber sheet is less than 20%, the thin sheet metal does not greatly decrease the electrical resistance of the electrode, whereby the high sheet resistance of the metal fiber sheet may cause a problem. When the area of the line pattern of the thin sheet metal on the surface of the metal fiber sheet is more than 80%, the exposed area of the metal fiber sheet is small. As a result, feeding efficiencies of fuel and an oxidant are decreased, and the power generating efficiency of the fuel cell is thereby decreased.

The present invention may be used for a fuel cell using the above-described fuel cell electrode. Specifically, the above fuel cell electrode is suitably used in a flat stacked-type fuel cell in which single electric power generating cells are flatly arranged and are connected in series. In the flat stacked-type fuel cell, an electric current flows in a direction parallel to the surfaces of electrodes. In the electrode of the present invention, the thin sheet metal functions as a bypass of an electric current so that the electric current may not flow in the metal fiber sheet in a direction parallel to the surface thereof. Accordingly, even when the electrical resistance of the metal fiber sheet in a direction parallel to the surface thereof is large, the power generating efficiency is not decreased.

The present invention provides a production method of electrodes, and the method comprises preparing a sheet-shaped metal fiber web and a metal thin sheet, a step for punching a metal fiber web having a predetermined shape from the metal fiber web, and a step for punching a thin sheet metal pattern from the metal thin sheet. The method also comprises a step for obtaining a laminated material by laminating the thin sheet metal pattern on the upper layer or the lower layer of the metal fiber web having the predetermined shape, or by laminating plural metal fiber webs having the predetermined shape and laminating the thin sheet metal pattern on the top layer or the bottom layer of the laminated metal fiber webs. The method further comprises a step for sintering the laminated material. In the present invention, the step for punching the metal fiber web and the step for punching the thin sheet metal pattern are desirably performed by the same die assembly.

### EFFECTS OF THE INVENTION

According to the present invention, the thin sheet metal pattern is laminated on the metal fiber sheet, whereby an electric current path in a direction parallel to the surface of the metal fiber sheet can be secured. Therefore, an electrode that may be suitably used for a flat stacked-type fuel cell can be obtained. Moreover, by using the electrode of the present invention, a fuel cell that can be operated at high power generating efficiency is obtained.

### BRIEF DESCRIPTION OF THE DRAWINGS

FIGS. 1A and 1B are perspective views showing a structure of a fuel cell electrode using the present invention.

FIGS. 2A and 2B are schematic views showing a production step of metal fibers.

FIG. 3 is a schematic view showing a production step of a metal fiber sheet.

FIG. 4 is a schematic view showing a production process of a fuel cell electrode.

FIGS. 5A and 5B are perspective views showing a basic single cell that makes up a fuel cell.

FIG. 6 schematically shows a cross sectional structure of a flat stacked-type fuel cell.

FIGS. 7A to 7C are top views showing other examples of shapes of a thin sheet metal.

### EXPLANATION OF REFERENCE NUMERALS

101 denotes a metal fiber sheet, 102 denotes a thin sheet metal, 103 denotes a fuel cell electrode, 104 denotes an opening portion provided to the thin sheet metal, 201 denotes an annular pattern, and 202 denotes a bridge portion.

### BEST MODE FOR CARRYING OUT THE INVENTION

### 1. First Embodiment

### Structure of Embodiment

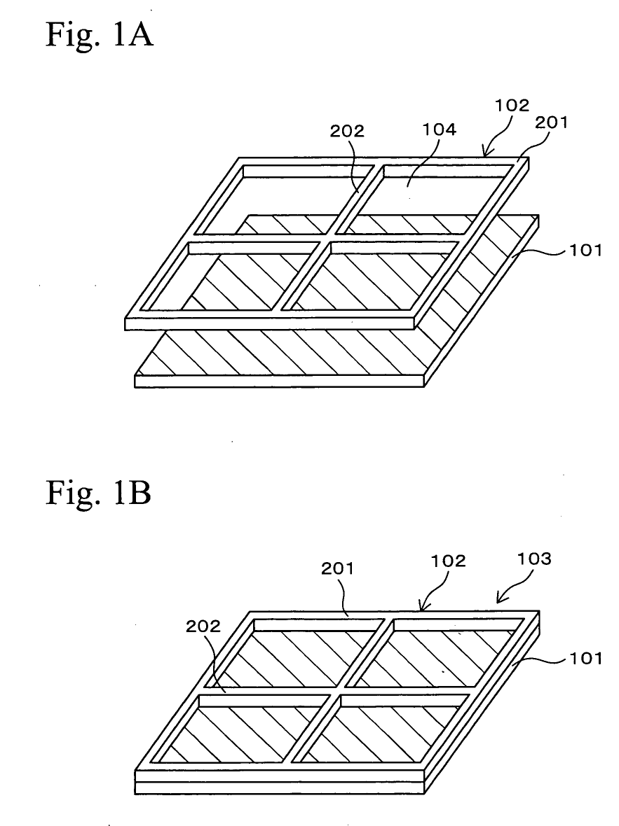

FIGS. 1A and 1B are perspective views showing a structure of a fuel cell electrode using the present invention, FIG. 1A shows a disassembled condition of the fuel cell electrode, and FIG. 1B shows a bonded condition of the fuel cell electrode. FIG. 1B shows a fuel cell electrode 103 including a thin sheet metal 102 and a metal fiber sheet 101. The thin sheet metal 102 is primarily made of Fe and Cr and has a rectangular annular pattern (framing pattern) 201 and a cross-shaped bridge portion 202 dividing the inside area of the annular pattern 201. The thin sheet metal 102 is provided with rectangular opening portions 104 at four portions at which the annular pattern 201 and the bridge portion 202 are not disposed and the metal fiber sheet 101 is thereby exposed. The metal fiber sheet 101 is made of the same material as that of the thin sheet metal 102. The material is formed into a fiber form with a wire diameter of 40 μm and is formed into a thin sheet shape, and the metal fiber sheet 101 is thereby fibriform and porous. As the material forming the metal fiber sheet 101 and the thin sheet metal 102, an FeCrSi alloy is most suitable, but a stainless steel or Ni—Cr alloy may also be used. The metal fiber sheet 101 and the thin sheet metal 102 may be made of different materials, and the combination of the materials is desirably selected so that the materials can be bonded by sintering.

The metal fiber sheet 101 and the thin sheet metal 102 are diffusion bonded by sintering. The thin sheet metal 102 functions as a collecting electrode which collects an electric current so that the electric current will not flow in the metal fiber sheet 101 in a direction parallel to the surface thereof. As a result, the electric current flows in the thin sheet metal 102 in a direction parallel to the surface of the metal fiber sheet 101. Therefore, when an electric current flows in a direction parallel to the surface of the metal fiber sheet 101, generated power loss due to the relatively high sheet resistance of the metal fiber sheet 101 can be reduced. Moreover, the metal fiber sheet 101 and the thin sheet metal 102 are diffusion bonded, whereby the contact resistance therebetween is sufficiently reduced, and the contact resistance at the bonded portion will not be increased by corrosion.

As shown in FIGS. 1A and 1B, the pattern of the thin sheet metal 102 includes an annular pattern 201 and a bridge portion 202. The annular pattern 201 surrounds the peripheral edge portion of the metal fiber sheet 101, and the bridge portion 202 runs on the metal fiber sheet 101 lengthwise and crosswise inside the annular pattern 201. According to this structure, an opening ratio of the opening portion 104 necessary for feeding fuel and an oxidant can be efficiently secured. Moreover, by providing the bridge portion 202, the exposed surface of the metal fiber sheet 101 is divided lengthwise and crosswise, whereby a collecting efficiency of an electric current from the metal fiber sheet 101 can be increased. Furthermore, by providing the bridge portion 202, the thin sheet metal 102 and the metal fiber sheet 101 are strongly bonded.

### Production Method

Hereinafter, an example of a production process for the fuel cell electrode 103 shown in FIGS. 1A and 1B will be described. Metal fibers for forming the metal fiber sheet 101 are desirably obtained by a molten metal extraction method. Metal fibers obtained by the molten metal extraction method have a noncircular shape in cross section and have a shape that is not uniform in a longitudinal direction. A metal fiber porous material made of such metal fibers obtained by the molten metal extraction method has a larger volume content. On the other hand, a metal fiber porous material made of metal fibers having a circular shape in cross section and a uniform shape has a smaller volume content, even when the same compressive pressure as that in the above metal fiber porous material is used. This is because the metal fibers obtained by the molten metal extraction method are easily entangled with each other by compression, and springback is thereby small when a compressive load is removed.

Next, examples of production methods of a metal fiber sheet and a fuel cell electrode using the metal fiber sheet will be described in the order of steps.

### A. Production Step of Metal Fiber

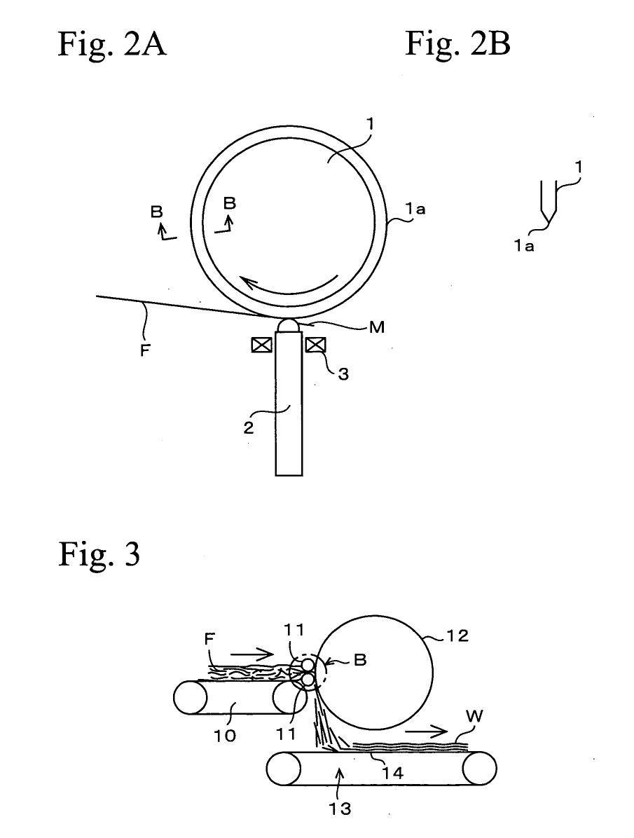

FIG. 2A is a schematic view showing a molten metal extraction apparatus, and FIG. 2B shows a cross sectional shape taken along line B-B of FIG. 2A. FIGS. 2A and 2B show a reference numeral 1 indicating a roller that is formed with an edge 1a at the outer periphery. A material holder 2 is arranged at the lower side of the roller 1 and has an axis line in a vertical direction. A metal wire rod is contained in the material holder 2 so as to be upwardly movable. A heating coil 3 is disposed at the upper end portion of the material holder 2 so as to melt a material M that is protruded from the upper end of the material holder 2. The molten material M contacts the edge 1a of the roller 1, and the molten metal M is pulled out toward the tangential direction of the roller 1 and is rapidly cooled, whereby metal fibers F having a uniform wire diameter are produced. In this case, the fiber diameters of the metal fibers F are set to be 40 μm in terms of a circular shape.

### B. Fibrillating and Forming Web Steps

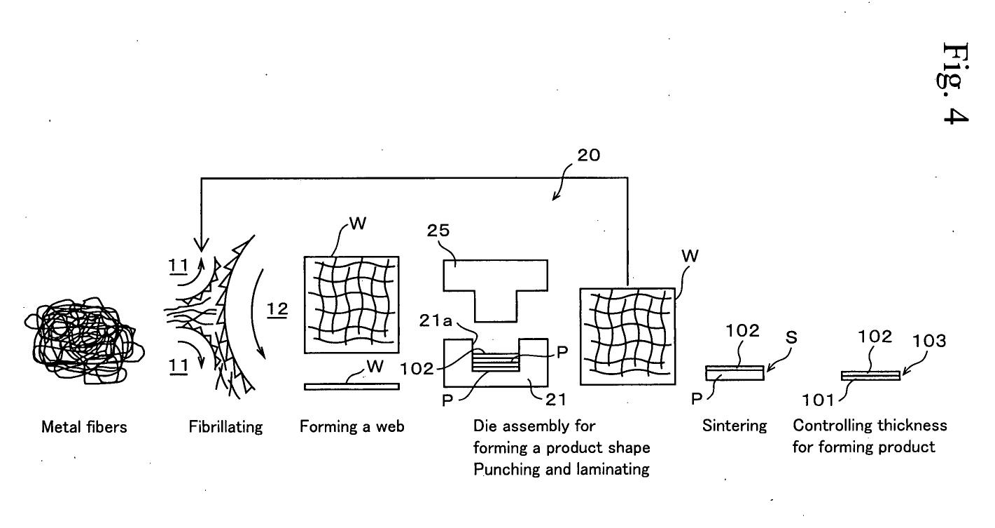

FIG. 3 is a schematic view showing a production step of a web using the metal fibers produced by the above step. As shown in FIG. 3, an aggregate of the metal fibers F is fed to a material conveyer 10 and is conveyed to an outlet side. A feeding roller 11 is arranged at the outlet of the material conveyer 10, and a fibrillating device 12 is arranged at the outside of the feeding roller 11. The feeding roller 11 is formed with plural teeth at the outer periphery so as to bite and forward the metal fibers F (see FIG. 4). The fibrillating device 12 is also formed with plural teeth at the outer periphery, and the fibrillating device 12 cards a part of the metal fibers F bitten by the feeding roller 11 and drops the metal fibers F on a belt 14 of a conveyer 13. This is a fibrillating step, and the metal fibers F are divided and are mixed in random directions on the belt 14 during the fibrillating step, whereby the metal fibers F are formed so as to be a sheet-shaped web W such as a nonwoven fabric.

Since the material conveyer 10 is fed with the metal fibers-as they are produced by the molten metal extraction method, the wire diameters of the aggregate of the metal fibers are approximately the same. The present invention is not limited to that case, and an aggregate of other metal fibers may be mixed into the above aggregate. The other metal fibers may be produced by another step so as to have a wire diameter different from that of the above metal fibers.

### C. Punching and Laminating Steps

FIG. 4 is a schematic view showing a production process of a fuel cell electrode and shows a die assembly 20 used in a punching step. The die assembly 20 includes a die 21 and a punch 25 that is insertable in a hole 21a of the die 21. The web W is conveyed to the die assembly 20, and a punched material P is punched out from the web W by lowering the punch 25. There is a friction between the inner peripheral edge of the hole 21a of the die 21 and the punched material P. Therefore, the punched material P does not fall and remains in the hole 21a, and the punched material P is pressed by a successive punched material P and goes down in sequence.

After a predetermined amount of the punched material P is punched out, a thin sheet metal 102 is punched out from a thin sheet metal by the above die assembly 20. In this case, the thin sheet metal 102 is previously punched by another die assembly so as to have openings 104 (see FIGS. 1A and 1B) at the center thereof. The thin sheet metal 102 punched out from the thin sheet metal and the punched material P laminated in the hole 21a are compressed between the punch 25 and the bottom of the hole 21a. In this case, the web W to be punched may have a single layer or plural layers, and the number of the layer is selected according to the thickness and the bulk density required for a metal fiber sheet that will be obtained in the end. The thin sheet metal 102 may be punched out from the thin sheet metal before a predetermined amount of the punched material P is produced. Then, a lifter (not shown in the figure) provided at the bottom of the hole 21a is raised, and the laminated punched materials P and the thin sheet metal 102 are protruded from the upper surface of the die 21.

The fiber density of the web used in one punching is desirably 100 to 2000 g/m². If the fiber density of the web is less than 100 g/m², the metal fibers of the web are easily dispersed when the web is punched. On the other hand, if the fiber density of the web is more than 2000 g/m², the side of the web is likely to dangle downwardly.

### D. Sintering Step

The laminated punched materials P and the thin sheet metal 102 are pulled out from the die assembly 20 by a carrying device (not shown in the figure) and are conveyed to a sintering furnace. On the other hand, after the punched material P is punched out from the web W, the rest of the web W is returned to the fibrillating step and is recycled into metal fibers so as to be used as a material for a web W.

A continuous furnace is used as the sintering furnace. The laminated punched materials P and the thin sheet metal 102 are sintered while passing through the sintering furnace without a load. Then, contacting portions between the metal fibers and contacting portions between the metal fibers and the thin sheet metal 102 are diffusion bonded each other, whereby a composite material S as a sheet-shaped sintered material made of the metal fiber sheet 101 and the thin sheet metal 102 is produced. The composite material S is machined mechanically so as to have a predetermined sheet thickness, for example, and a fuel cell electrode 103 in which the metal fiber sheet 101 and the thin sheet metal 102 are bonded can be obtained. According to this production process, the web W and the thin sheet metal 102 are punched by the same die assembly, whereby the production process can be simple, and the production cost can be reduced.

### Evaluation

Evaluation results of the fuel cell electrode shown in FIGS. 1A and 1B will now be described. In this case, the following samples were prepared. A metal fiber sheet 101 had a size of 60 mm×60 mm×0.2 mm (thickness), and a metal fiber had a diameter of 40 μm in terms of a circular shape. A thin sheet metal 102 had a size of 60 mm×60 mm, and an annular pattern 201 and a bridge portion 202 of the thin sheet metal 102 had widths of 3 mm. The following Table 1 shows materials, Cr content, thermal expansion coefficient β, and bulk density Vf of the metal fiber sheet 101, and Table 1 also shows Cr content, thermal expansion coefficient β, and sheet thickness of the thin sheet metal 102. When the above sizes are used, the line pattern of the thin sheet metal 102 covers the metal fiber sheet 101 at 27.75% of the surface area thereof.

TABLE 1

| | Metal fiber sheet | | | | Thin sheet metal | | | |
|---|---|---|---|---|---|---|---|---|
| | | Cr | | | | Cr | | Sheet |
| | | amount | β | Vf | | amount | β | thickness |
| Samples | Material | (wt %) | (×10⁻⁶/K) | (%) | Material | (wt %) | (×10⁻⁶/K) | (mm) |
| Production example 1 | FeCrSi | 20 | 11.3 | 20 | FeCrSi | 20 | 11.3 | 0.2 |
| Production example 2 | FeCrSi | 20 | 11.3 | 40 | FeCrSi | 20 | 11.3 | 0.2 |
| Production example 3 | FeCrSi | 20 | 11.3 | 60 | FeCrSi | 20 | 11.3 | 0.2 |
| Production example 4 | FeCrSi | 20 | 11.3 | 20 | FeCrSi | 20 | 11.3 | 0.5 |
| Production example 5 | FeCrSi | 20 | 11.3 | 40 | FeCrSi | 20 | 11.3 | 0.5 |
| Production example 6 | FeCrSi | 20 | 11.3 | 60 | FeCrSi | 20 | 11.3 | 0.5 |
| Production example 7 | FeCrSi | 20 | 11.3 | 20 | FeCrSi | 20 | 11.3 | 1.0 |
| Production example 8 | FeCrSi | 20 | 11.3 | 40 | FeCrSi | 20 | 11.3 | 1.0 |
| Production example 9 | FeCrSi | 20 | 11.3 | 60 | FeCrSi | 20 | 11.3 | 1.0 |
| Production example 10 | FeCrSi | 20 | 11.3 | 40 | SUS430 | 17 | 10.4 | 0.2 |
| Production example 11 | FeCrSi | 20 | 11.3 | 40 | SUS430 | 17 | 10.4 | 0.5 |
| Production example 12 | FeCrSi | 20 | 11.3 | 40 | SUS430 | 17 | 10.4 | 1.0 |
| Production example 13 | SUS304 | 18 | 17.3 | 40 | SUS430 | 17 | 10.4 | 0.2 |
| Production example 14 | SUS304 | 18 | 17.3 | 40 | SUS430 | 17 | 10.4 | 0.5 |
| Production example 15 | SUS304 | 18 | 17.3 | 40 | SUS430 | 17 | 10.4 | 1.0 |
| Production example 16 | SUS304 | 18 | 17.3 | 40 | FCHW1 | 24 | 13.0 | 1.0 |
| Production example 17 | SUS304 | 18 | 17.3 | 40 | SUS316 | 16 | 15.9 | 1.0 |
| Production example 18 | SUS304 | 18 | 17.3 | 40 | SUS316L | 16 | 16.5 | 1.0 |
| Production example 19 | FCHW1 | 24 | 13.0 | 40 | FeCrSi | 20 | 11.3 | 1.0 |
| Production example 20 | FCHW1 | 24 | 13.0 | 40 | SUS430 | 17 | 10.4 | 1.0 |
| Production example 21 | SUS403 | 12 | 9.9 | 40 | SUS430 | 17 | 10.4 | 0.2 |
| Production example 22 | SUS329J1 | 28 | 13.1 | 40 | SUS430 | 17 | 10.4 | 0.2 |

Bonding strength between the metal fiber sheet 101 and the thin sheet metal 102 and degree of bending thereof were investigated with respect to the production examples 1 to 22 shown in Table 1, and the results are shown in the following Table 2. In this case, when the metal fiber sheet 101 and the thin sheet metal 102 were strongly bonded by the entire surfaces thereof and had no separation therebetween, the bonding strength was categorized as being good (o). When the metal fiber sheet 101 and the thin sheet metal 102 were partially separated from each other, but they were strongly bonded by bonded portions and might not be separated from each other during handling, the bonding strength was categorized as being not inferior (Δ). When the metal fiber sheet 101 and the thin sheet metal 102 were partially separated from each other, and the bonded portions might be separated during handling, the bonding strength was categorized as being inferior (x).

When there was almost no bending (0 to less than 0.1 mm), a catalyst coating method such as brush coating, spray coating, screen printing, and the like, may be easily performed, and an MEA (Membrane Electrode Assembly) could be fabricated by hot pressing without causing problems. In this case, the degree of bending was categorized as being very good (⊚). When there was a slight bending (0.1 to less than 0.3 mm), the catalyst coating could be easily performed (in a case of screen printing, the thickness of a catalyst layer was slightly uneven), and an MEA could be fabricated by hot pressing without causing problems. In this case, the degree of bending was categorized as being good (o). When there was a large bending (0.3 to less than 1.0 mm), catalysts were not easily coated by screen printing, the fabrication of MEA had to be performed by hot pressing while adjusting a pressing speed, and the fuel cell electrode could be practically used without problems. In this case, the degree of bending was categorized as being not inferior (Δ). When there was a large bending (1.0 mm or more), the catalyst layer cracked during fabrication of the MEA, whereby the fuel cell electrode could not be used. In this case, the degree of bending was categorized as being inferior (x).

TABLE 2

Degree of bending

| | | bending | |
|---|---|---|---|
| | Degree of | amount | |
| Samples | bonding | (mm) | Results |
| Production example 1 | ◯ | 0.01 | ⊚ |
| Production example 2 | ◯ | 0.02 | ⊚ |
| Production example 3 | ◯ | 0.01 | ⊚ |
| Production example 4 | ◯ | 0.02 | ⊚ |
| Production example 5 | ◯ | 0.00 | ⊚ |
| Production example 6 | ◯ | 0.01 | ⊚ |
| Production example 7 | ◯ | 0.03 | ⊚ |
| Production example 8 | ◯ | 0.00 | ⊚ |
| Production example 9 | ◯ | 0.02 | ⊚ |
| Production example 10 | ◯ | 0.03 | ⊚ |
| Production example 11 | ◯ | 0.07 | ⊚ |
| Production example 12 | ◯ | 0.08 | ⊚ |
| Production example 13 | ◯ | 0.22 | ◯ |
| Production example 14 | ◯ | 0.39 | Δ |
| Production example 15 | ◯ | 0.47 | Δ |
| Production example 16 | ◯ | 0.41 | Δ |
| Production example 17 | ◯ | 0.24 | ◯ |
| Production example 18 | ◯ | 0.08 | ⊚ |
| Production example 19 | ◯ | 0.22 | ◯ |
| Production example 20 | ◯ | 0.26 | ◯ |
| Production example 21 | ◯ | 0.02 | ⊚ |
| Production example 22 | ◯ | 0.12 | ◯ |

As shown in Table 2, in all the production examples, bonding strengths were good. This is because the metal fiber sheet and the thin sheet metal were diffusion bonded by sintering and were thereby formed into one material. According to the results of the production examples 1 to 9, when the metal fiber sheet and the thin sheet metal have the same thermal expansion coefficients, there is almost no bending regardless of the Vf of the metal fiber sheet and the sheet thickness of the thin sheet metal. According to the results of the production examples 1 to 12, 18, and 21, when the difference in the thermal expansion coefficient between the metal fiber sheet and the thin sheet metal is not more than 1×10⁻⁶/K, there is almost no bending. According to the results of the production examples 17, 19, and 22, when the difference in the thermal expansion coefficient between the metal fiber sheet and the thin sheet metal is not more than 3×10⁻⁶/K, the amount of the bending is in a range in which problems will not occur in practical use. According to the result of the production example 13, when the thin sheet metal has a sheet thickness of not more than 0.2 mm, even if the difference of the thermal expansion coefficient is large, the amount of the bending is in a range in which problems will not occur in practical use. As shown by the results of the production examples 21 and 22, when the metal fiber sheet and the thin sheet metal are primarily made of Fe and Cr so as to contain Cr at approximately 10% or 30% by weight, the metal fiber sheet and the thin sheet metal are bonded in good condition. Accordingly, by forming the metal fiber sheet and the thin sheet metal so as to be primarily made of Fe and Cr and to contain Cr at 10 to 30% by weight, the bonding condition thereof can be good.

### 2. Second Embodiment

### Structure of Single Electric Power Generating Cell

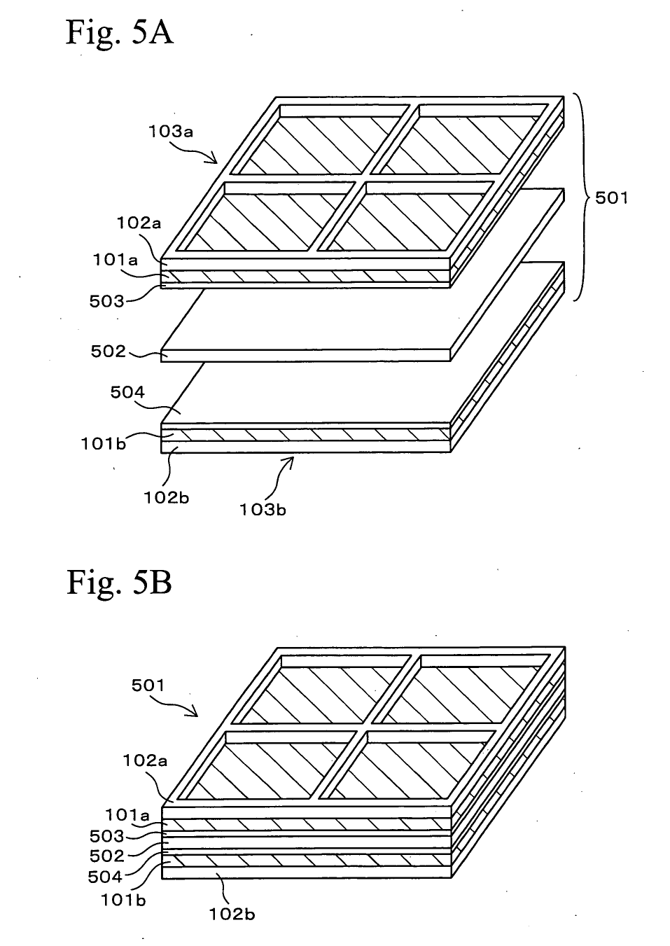

Next, an example of a fuel cell using the fuel cell electrode exemplified in the first embodiment will be described. FIGS. 5A and 5B show perspective views showing a structure of a single electric power generating cell of a fuel cell, FIG. 5A shows a disassembled condition of the structure, and FIG. 5B shows an assembled condition of the structure.

Hereinafter, an example of an assembling procedure will be described. First, two fuel cell electrodes shown in FIGS. 1A and 1B are prepared. FIG. 5A shows a fuel cell electrode 103a and a fuel cell electrode 103b. The fuel cell electrode 103a is formed by bonding the metal fiber sheet 101a and the thin sheet metal 102a, and the fuel cell electrode 103b has the same structure as that of the fuel cell electrode 103a and is upside down. After the fuel cell electrodes 103a and 103b are prepared, catalysts are coated on the surfaces of the metal fiber sheets thereof so as to form catalyst layers. FIG. 5A shows a condition in which a catalyst layer 503 is formed at the fuel cell electrode 103a and in which a catalyst layer 504 is formed at the fuel cell electrode 103b. Then, the surfaces formed with a catalyst layer are faced each other so as to put an electrolyte membrane 502 therebetween, and the fuel cell electrodes 103a and 103b are bonded by hot pressing. Thus, a single electric power generating cell 501 is obtained.

In the single electric power generating cell 501, the laminated portion, at which the electrolyte membrane 502 is held between the catalyst layers 503 and 504, functions as an MEA (Membrane Electrode Assembly). In the single electric power generating cell 501, the electrode 103a functions as an oxidant electrode (cathode), and the electrode 103b functions as a fuel electrode (anode).

In the above structure, by coating a catalyst material on the surface of the metal fiber sheet and forming a catalyst layer, the catalyst layer adheres to the metal fiber sheet more strongly. Since the surface of the metal fiber sheet has a fine asperity due to the entangled structure of the metal fibers, the contacting area of the metal fiber sheet and the catalyst layer can be increased. Moreover, the surface of the metal fiber sheet has an anchoring effect, whereby the catalyst layer adheres to the metal fiber sheet more strongly. The MEA may be obtained by forming the catalyst layers 503 and 504 on both sides of the electrolyte membrane 502 respectively. Then, this MEA may be placed between the surface of the metal fiber sheet of the electrode 103a and the surface of the metal fiber sheet of the electrode 103b.

### Operation of Single Electric Power Generating Cell

An operation of a single electric power generating cell will be described hereinafter, and in this case, electric power is generated by using an aqueous methanol solution as fuel and air as an oxidant. In the single electric power generating cell 501 shown in FIGS. 5A and 5B, an aqueous methanol solution is fed to the electrode 103b, and air is fed to the electrode 103a. The aqueous methanol solution permeates into the metal fiber sheet 101b and is exposed to the catalyst layer 504, and the air permeates through the metal fiber sheet 101a. The methanol exposed to the catalyst layer 504 is decomposed into hydrogen ions (H⁺) and electrons (e⁻). The hydrogen ions migrate through the electrolyte membrane 502 and the catalyst layer 503 to the metal fiber sheet 101a. The electrons are fed to the metal fiber sheet 101b. Thus, the metal fiber sheet 101a has a higher potential than that of the metal fiber sheet 101b.

Therefore, when the thin sheet metal 102a of the electrode 103a and the thin sheet metal 102b of the electrode 103b are electrically connected through a load, an electric current flows from the electrode 103a to the electrode 103b. In this case, in the catalyst layer 503, the oxygen in the air, the hydrogen ions permeated through the electrolyte membrane 502, and the electrons fed from the electrode 103b to the metal fiber sheet 101a react, whereby water is generated. Thus, electric power is generated by the fuel cell using the aqueous methanol solution as fuel.

### Flat Stacked-Type Fuel Cell

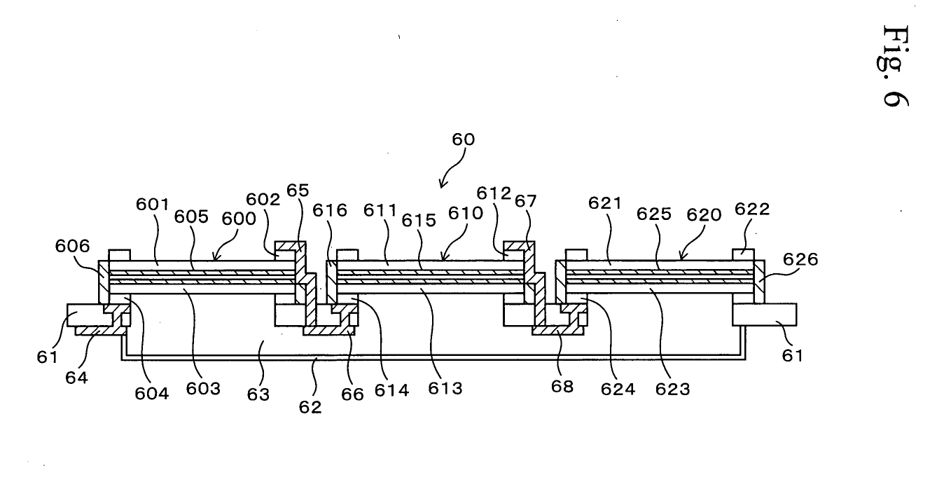

FIG. 6 shows a cross sectional structure of a fuel cell in which single electric power generating cells are flatly stacked. FIG. 6 shows a fuel cell 60 in which single electric power generating cells 600, 610, and 620, having the same structures, are flatly arranged and are electrically connected in series.

First, a structure of each single electric power generating cell will be described. Each of the single electric power generating cells has a basic structure shown in FIGS. 5A and 5B. For example, in the case of the single electric power generating cell 600, an MEA 605 is formed by putting an electrolyte membrane between catalyst layers, and an oxidant electrode 601 made of a metal fiber sheet is arranged on the upper side of the MEA 605. Moreover, a collecting electrode 602 made of a thin sheet metal is diffusion bonded on the oxidant electrode 601. A fuel electrode 603 made of a metal fiber sheet is arranged on the lower surface of the MEA 605, and a collecting electrode 604 made of a thin sheet metal is diffusion bonded on the lower surface of the fuel electrode 603. The oxidant electrode 601 corresponds to the metal fiber sheet 101a shown in FIGS. 5A and 5B, and the collecting electrode 602 corresponds to the thin sheet metal 102a. The fuel electrode 603 corresponds to the metal fiber sheet 101b shown in FIGS. 5A and 5B, and the collecting electrode 604 corresponds to the thin sheet metal 102b.

The other single electric power generating cells have the same structures as that of the single electric power generating cell 600. In the single electric power generating cell 610, an oxidant electrode 611 made of a metal fiber sheet is arranged on the upper surface of an MEA 615, and a collecting electrode 612 made of a thin sheet metal is diffusion bonded on the oxidant electrode 611. Moreover, a fuel electrode 613 made of a metal fiber sheet is arranged on the lower surface of the MEA 615, and a collecting electrode 614 made of a thin sheet metal is diffusion bonded on the lower surface of the fuel electrode 613. In the single electric power generating cell 620, an oxidant electrode 621 made of a metal fiber sheet is arranged on the upper surface of an MEA 625, and a collecting electrode 622 made of a thin sheet metal is diffusion bonded on the oxidant electrode 621. Moreover, a fuel electrode 623 made of a metal fiber sheet is arranged on the lower surface of the MEA 625, and a collecting electrode 624 made of a thin sheet metal is diffusion bonded on the lower surface of the fuel electrode 623.

In the fuel cell 60, an extraction electrode 64 contacts the collecting electrode 604 of the single electric power generating cell 600, and the collecting electrode 602 of the single electric power generating cell 600 contacts a connecting electrode 65. The connecting electrode 65 is connected to the collecting electrode 614 of the single electric power generating cell 610 through a connecting electrode 66. The collecting electrode 612 of the single electric power generating cell 610 contacts a connecting electrode 67. The connecting electrode 67 is connected to the collecting electrode 624 of the single electric power generating cell 620 through a connecting electrode 68. Thus, the fuel electrodes and the oxidant electrodes of the single electric power generating cells 600, 610, and 620 are alternately connected and form a series-connected structure. In this case, a side peripheral edge of each of the single electric power generating cells is sealed by a sealing member 606, 616, or 626, respectively. A reference numeral 62 indicates a fuel container for containing an aqueous methanol solution, and the aqueous methanol solution is filled into the inside 63 of the fuel container 62.

In order to generate electric power by the fuel cell shown in FIG. 6, the aqueous methanol solution is filled into the fuel container 62, and the oxidant electrodes are exposed to air. Then, the extraction electrode 64 and the collecting electrode 622 are electrically connected through a load (not shown in the figure). As a result, each of the single electric power generating cells operates as described above and generates electric power, whereby an electric current flows from the collecting electrode 622 to the extraction electrode 64 through the load (not shown in the figure).

The fuel electrodes 603, 613, and 623 and the oxidant electrodes 601, 611, and 621 are arranged so as to result in an electric current flowing therein in a direction parallel to the surfaces thereof during an electric power generation. This phenomenon is unavoidable when a flat stacked structure is used for a fuel cell. For example, in the structure shown in FIG. 6, if the collecting electrodes 602, 612, and 622 are not so arranged, an electric current flows in the metal fiber sheets forming the oxidant electrodes 601, 611, and 621 in a direction parallel to the surfaces thereof. In this case, since electrical resistance (sheet resistance) in a direction parallel to the surface of the metal fiber sheet is relatively large, power loss occurs. In this embodiment, the oxidant electrodes 601, 611, and 621 are connected to the collecting electrodes 602, 612, and 622 made of the thin sheet metals, respectively. As shown in FIGS. 1A, 1B, 5A, and 5B, each of the collecting electrodes includes an annular pattern 201 and a bridge portion 202. The annular pattern 201 covers the edge portion of the metal fiber sheet forming the oxidant electrode, and the bridge portion 202 divides the inside area of the annular pattern 201 crosswise and lengthwise. These collecting electrodes function as bypasses for an electric current so that the electric current will not flow in the metal fiber sheet in a direction parallel to the surface thereof. Therefore, a large amount of an electric current does not flow in the oxidant electrodes 601, 611, and 621 in a direction parallel to the surfaces thereof, and the electric current primarily flows in the collecting electrodes 602, 612, and 622. This function also occurs at the side of the fuel electrodes. Accordingly, even when the sheet resistance of the metal fiber sheet is relatively large, power loss due to the high sheet resistance can be reduced, whereby decrease of the electric power generating efficiency of the fuel cell can be avoided. Specifically, when the metal fiber sheet is made thinner so as to decrease the thickness and the weight of the fuel cell, the above-described effect of the sheet resistance becomes apparent. However, by using the present invention, the decrease in the electric power generating efficiency can be avoided due to the above described function.

The flat stacked-type fuel cell shown in FIG. 6 can be made thinner and is thereby suitably used for driving sources of electronics having a thin thickness. For example, the flat stacked-type fuel cell is suitably used for electric sources for mobile phones, personal digital assistants, notebook personal computers, portable audio-visual devices, and the like. The fuel cell using methanol as fuel is suitably used for these devices in view of the ease of obtaining fuel and the ease of handling. It should be noted that a fuel cell, to which the present invention can be applied, is not limited to a fuel cell that uses methanol as fuel.

### 3. Other Embodiments

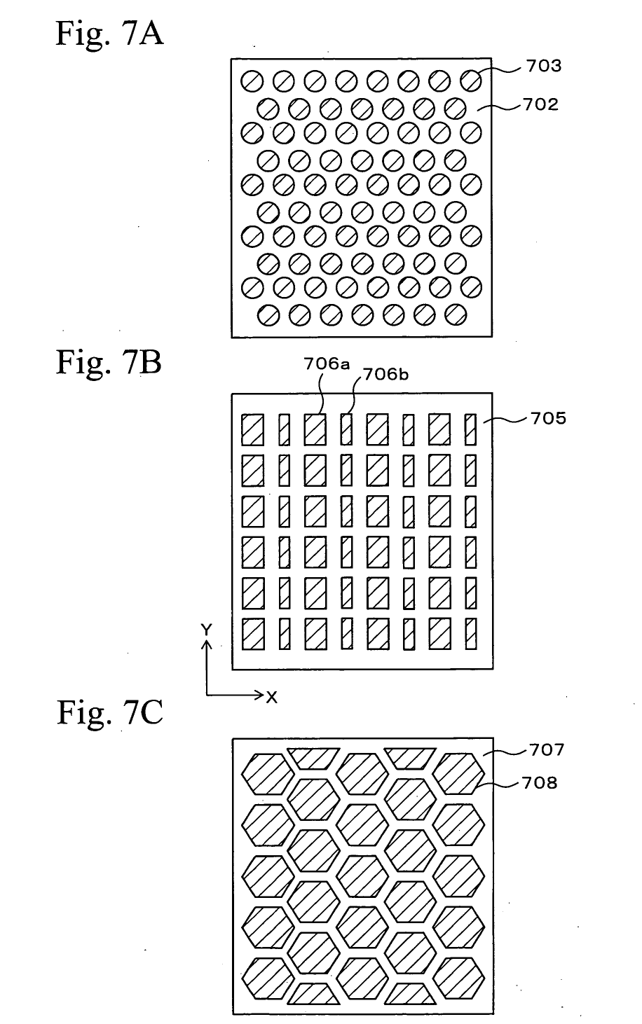

Other examples of the shape of the collecting electrode of the fuel cell electrode using the present invention will be described. FIGS. 7A to 7C are top views showing other examples of the pattern of the collecting electrode. FIG. 7A is a top view showing other example of the pattern shape of a thin sheet metal which is used to form a collecting electrode. In this example, plural circular holes 703a are formed in a thin sheet metal 702 having a rectangular shape. The thin sheet metal 702 is bonded to a metal fiber sheet (not shown in the figure) that is laminated on the thin sheet metal 702, and the metal fiber sheet under the thin sheet metal 702 is exposed at the circular holes 703. In this structure, the peripheral edge portion corresponds to the annular pattern, and the portions between the plural circular holes 703 correspond to the bridge portion. The pattern of the thin sheet metal 702 shown in FIG. 7A is produced easily.

The practical range of an opening ratio of the metal fiber sheet exposed was investigated by using the pattern of the thin sheet metal 702 shown in FIG. 7A, and the results will be described hereinafter. In this experiment, samples of single electric power generating cells were formed, and the single electric power generating cells had anodes and cathodes that were made by changing the size of the holes 703. These single electric power generating cells were operated under the same conditions, and the amounts of generated electric power were measured. In this experiment, the samples were made so that an electric current generated would flow in a direction parallel to the surface of the electrodes on the assumption that the samples might be used for a flat stacked-type fuel cell shown in FIG. 6. According to the experiment, when the metal fiber sheet is exposed at 20 to 80%, electric power can be generated. That is, when the ratio of the thin sheet metal covering the metal fiber sheet is 80 to 20%, the electric generating capacity of the fuel cell is not decreased. When the opening ratio of the metal fiber sheet is less than 20%, the electric power-generating efficiency is decreased, because the efficiency of feeding fuel and an oxidant through the metal fiber sheet is decreased. When the opening ratio of the metal fiber sheet is greater than 80%, the electric power generating efficiency is decreased. In this case, since the electric current path through the thin sheet metal is small, the effect of the thin sheet metal collecting an electric current is decreased. Therefore, the influence of the high sheet resistance of the metal fiber sheet becomes apparent.

FIG. 7B is a top view showing another example of the pattern shape of the thin sheet metal which is used to form a collecting electrode. In this example, two kinds of rectangular openings 706a and 706b are formed in a thin sheet metal 705 having a rectangular shape. The openings 706a and 706b have rectangular shapes that are thin in the X direction and are long in the Y direction. The openings 706a and 706b have different sizes in width direction (in the X direction). In the pattern shape of the thin sheet metal shown in FIG. 7B, the electric current path in the Y direction can be wide. Therefore, by arranging electrodes so that an electric current flows in the Y direction, the opening ratio of the openings 706a and 706b are secured, and the sheet resistance of the metal fiber sheet can be decreased by the thin sheet metal 705.

FIG. 7C is a top view showing another example of the pattern shape of the shin sheet metal which is used to form a collecting electrode. In this example, hexagonal openings 708 are regularly provided to a thin sheet metal 707 having a rectangular shape. According to this design, when a single electric power generating cell is formed, fuel and an oxidant can be fed to an MEA (not shown in the figure) in a uniform way.

### INDUSTRIAL APPLICABILITY

The present invention can be used for electrodes of fuel cells, and specifically, the present invention can be used for electrodes of flat stacked-type fuel cells.

1. An electrode comprising:
a metal fiber sheet; and
a thin sheet metal pattern connected to the surface of the metal fiber sheet and having a line pattern that runs on the metal fiber sheet, wherein the line pattern includes an annular pattern that is provided on the peripheral edge of the metal fiber sheet and has an inside area, and the line pattern includes a bridge portion dividing the inside area of the annular pattern.

2. The electrode according to claim 1, wherein the metal fiber sheet is made of an alloy of Fe and Cr, and Cr is included in the metal fiber sheet at 10 to 30% by weight.

3. The electrode according to claim 2, wherein the thin sheet metal pattern is made of the same material as that of the metal fiber sheet.

4. The electrode according to claim 1, wherein the difference in thermal expansion coefficient between the metal fiber sheet and the thin sheet metal pattern is not more than 3×10⁻⁶/K.

5. The electrode according to claim 1, wherein the difference in the thermal expansion coefficient between the metal fiber sheet and the thin sheet metal pattern is not more than 1×10⁻⁶/K.

6. The electrode according to claim 1, wherein the thin sheet metal pattern has a thickness of not more than 0.2 mm.

7. The electrode according to claim 1, wherein the metal fiber sheet and the thin sheet metal pattern are connected by diffusion bonding.

8. A fuel cell electrode using the electrode according to claim 1, wherein the line pattern covers the surface of the metal fiber sheet at 20 to 80%.

9. A fuel cell having electrodes using the fuel cell electrodes according to claim 8.

10. A fuel cell comprising:
electrodes using the fuel cell electrodes according to claim 8; and
plural single electric power generating cells that are flatly arranged and are connected in series so as to form a flat stacked structure.

11. A production method of an electrode, comprising:
preparing a sheet-shaped metal fiber web and a metal thin sheet;
a step for punching a metal fiber web having a predetermined shape from the sheet-shaped metal fiber web, the metal fiber web having an upper layer and a lower layer;
a step for punching a thin sheet metal pattern from the metal thin sheet;
a step for obtaining a laminated material by laminating the thin sheet metal pattern on the upper layer or the lower layer of the metal fiber web, or by laminating plural metal fiber webs and laminating the thin sheet metal pattern on the top layer or the bottom layer of the laminated metal fiber webs; and
a step for sintering the laminated material.

12. The production method of the electrode according to claim 11, wherein the step for punching the metal fiber web and the step for punching the thin sheet metal pattern are performed by the same die assembly.
